(19) United States
(12) Patent Application Publication
(10) Pub. No.: US 2002/0153707 A1
(43) Pub. Date: Oct. 24, 2002

(54) Folding cart

(76) Inventor: Darren Kady, Glen Allen, VA (US)

Correspondence Address: Parker & DeStefano, Suite 300, 300 Preston Avenue, Charlottesville, VA, 22902, US

(21) Appl. No.: 10/127,169

(22) Filed: Apr. 22, 2002

Related U.S. Application Data
(60) Provisional application No. 60/285,513, filed on Apr. 20, 2001.

(51) Int. Cl. B62B 1/12

(52) U.S. Cl. 280/652

(57) ABSTRACT

A folding cart for the transportation of articles having a foldable platform, wheels is provided with , a handle and a pair of telescoping braces. Each of the telescoping braces have a lower brace, a middle brace and an upper brace and rotatable support bars there between. The telescoping braces connect the platform and the handle. An offset handle hinge is provided on the first of the pair of telescoping braces. It rotatably connects the handle to the first of the pair of telescoping braces. When the handle is locked in a horizontal position the folding cart is precluded from being folded.

### RELATE BACK

This application incorporates by reference, as through recited in full, and claims the benefit of U.S. provisional application 60/285,513 filed Apr. 20, 2001.

### BACKGROUND OF THE INVENTION

1. Field of the Invention

This invention relates to an improved folding cart to facilitate the carrying of luggage and the like.

2. Brief Description of the Prior Art

Several types of collapsible and foldable carts for transporting articles or goods have been utilized in the past. Generally, these types of foldable carts are used by home owners for transporting of groceries, packages, luggage, duffle bags, ski bags, bowling bags, baseball storage bags, and the like. These foldable carts are also used for commercial and light industry usage in the transporting of in process goods, finished products, and the like. The collapsible and foldable nature of these carts provides for easy storage in a vehicle trunk, a storage closet, on a wall, and the like. These carts permit the transport of goods up and down walkways, stairs, escalators, steep hills, dirt trails, and the like, without causing damage to walkway surfaces, such as linoleum, tile, wood, or carpeting.

Luggage carts or trolleys for pulling or pushing by hand typically have a wheeled base for supporting luggage and a handle projecting upwardly from the base. These are typically collapsible at least to some extent so that they can be carried while not in use or stowed away in a small space, such as under the seat of an aircraft. U.S. Pat. No. 4,299,403 of Breweriet al., for example, describes a wheeled carrier in which the handle section can be folded downwardly when not in use. However, the cart is still relatively bulky even when collapsed. In U.S. Pat. No. 3,007,710 of Sykes, a collapsible cart has two, telescopically collapsible legs hinged together at one end and having wheels at their opposite, free ends. The free ends of the legs are pulled apart into a divergent configuration when the cart is used, with the spaced legs being held apart by means of a brace when deployed. This is a relatively cumbersome and heavy device.

### BRIEF DESCRIPTION OF THE DRAWINGS

The advantages of the instant disclosure will become more apparent when read with the specification and the drawings, wherein:

FIG. 1 is a perspective side view of the unfolded cart of the disclosed invention;

FIG. 2 is a front view of the disclosed cart of FIG. 1;

FIG. 3 is a back view of the cart of FIG. 1 with the handle in the partially open position;

FIG. 4 is a perspective view of the cart in a partially close position;

FIG. 5 is a perspective view of the lower locking button and folding release system;

FIG. 6 is a perspective view of the top of the lower hinge illustrating the button release alcove;

FIG. 7 is a perspective view of the platform extensions;

FIG. 8 is a side view of the platform extension with the legs open;

FIG. 9 is a side view of the extension leg in the closed position;

FIG. 10 is a side view of the of the extension leg in the open, locked positionABSTRACT A folding cart for the transportation of articles having a foldable platform, wheels is provided with, a handle and a pair of telescoping braces. Each of the telescoping braces have a lower brace, a middle brace and an upper brace and rotatable support bars there between. The telescoping braces connect the platform and the handle. An offset handle hinge is provided on the first of the pair of telescoping braces. It rotatably connects the handle to the first of the pair of telescoping braces. When the handle is locked in a horizontal position the folding cart is precluded from being folded.

FIG. 11 is a bottom view of the handle lock without the handle in place;

FIG. 12 is a bottom view of the handle lock with the handle in place;

FIG. 13 is an end view of the handle lock without the handle e;

FIG. 14 is a top view of the bottom portion of the center lock;

FIG. 15 is a side view of the central lock engaged;

FIG. 16 is a side view of the central lock disengaged;

FIG. 17a is a top view of the center lock in the engaged position;

FIG. 17b is a bottom view of the center lock in the engaged position;

FIG. 18a is a top view of the center lock in the disengaged position;

FIG. 18b is a bottom view of the center lock in the disengaged position;

FIG. 19 is a cutaway view of an alternate embodiment of the central lock;

FIG. 20 is a side view of a removable bungle cord holder;

FIG. 21 is a perspective view of an alternate embodiment of the platform locking mechanism;

FIG. 22 is another embodiment of an additional platform locking system;

FIG. 23 is a bottom view of an alternate embodiment having a single centralized platform leg;

FIG. 24 is a bottom view of a locking method for the platform leg;

FIG. 25 is a bottom view of an additional method of locking the platform leg;

FIG. 26 is a side view of the platform leg lock of FIG. 16 in the open position; and

FIG. 27 is a side view of the platform leg lock of FIG. 16 in the closed position.

### DETAILED DESCRIPTION OF THE INVENTION

Although folding carts are known in the prior art, none of the carts have provided a sturdy, lightweight collapsible carrying device. The prior art devices tend to be compact and lightweight but flimsy or sturdy but heavy and bulky. The disclosed folding cart provides a compact lightweight device that is easy to use and capable of carrying heavy loads.

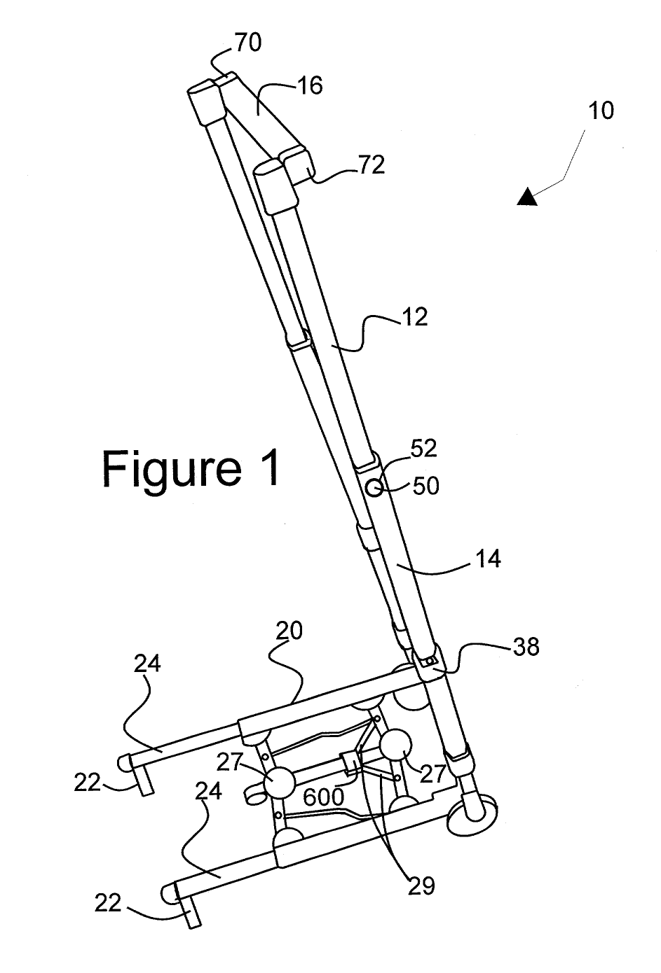

In FIG. 1 the cart 10 is illustrated in the unfolded, ready to use position. The handle 16 in this Figure is in the closed position, ready to grip, and the upper handle brace 12 and mid-handle brace 14 are fully extended. The upper handle brace 12 and the mid-handle brace 14 are maintained in the extended position through the use of press in buttons that interact with receiving holes. Although press in buttons and receiving holes has been used in the prior art, collapsing the telescoping legs has been accomplished manually or through a release button. It should be noted that for the cart 10 to fold, the handle 16 must be released and as long as the handle is maintained in the closed position, the cart will remain in the upright position.

In order to enable the handle 16 to swing into a position adjacent to the upper brace 12, the handle hinge 70 and the handle receiving end 72 are both off-set between the brace connection and the handle connection. Without the offset design, the handle would fall on the inside of the upper brace, preventing the cart from completely folding. To maintain a compact design, the offset should be only the width of the handle 16 with sufficient clearance to enable the handle to easily swing into position.

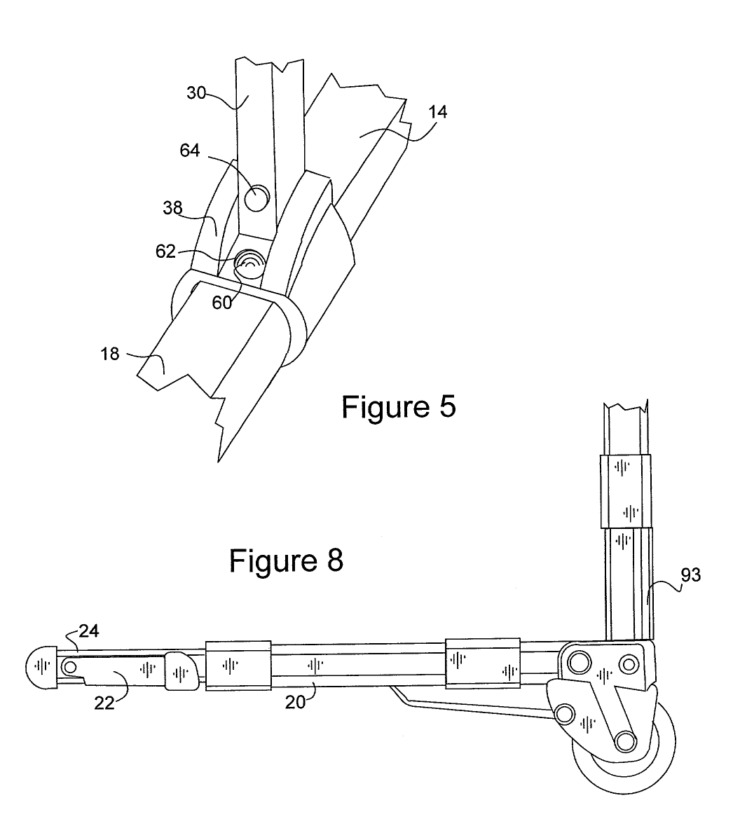

Preferably the upper brace 12 is maintained in position through use of upper brace button 50 and mid-brace receiving hole 52. The mid-brace 14 and lower brace 18 are maintained in position through use of a lower brace button 60 and lower brace receiving hole 62, illustrated in FIG. 5. The lower brace receiving hole 62, illustrated clearly in FIG. 5, is within the upper hinge 38 and catches the lower brace button 60 as it slides within the upper hinge 38, as known in the art. The corresponding cross support 30 has a nipple 64 that is positioned to press the lower brace button 60 inward as the cart 10 is closed, allowing the mid-brace 14 to side into the bottom brace 18. The nipple 64 must be dimensioned to release the lower brace button 60 without interfering with the sliding of the mid-brace 14. As the cart 10 is opened, the nipple 64 is removed from the receiving hole 62 and release the button 60 to catch as the mid-brace 14 is moved upward.

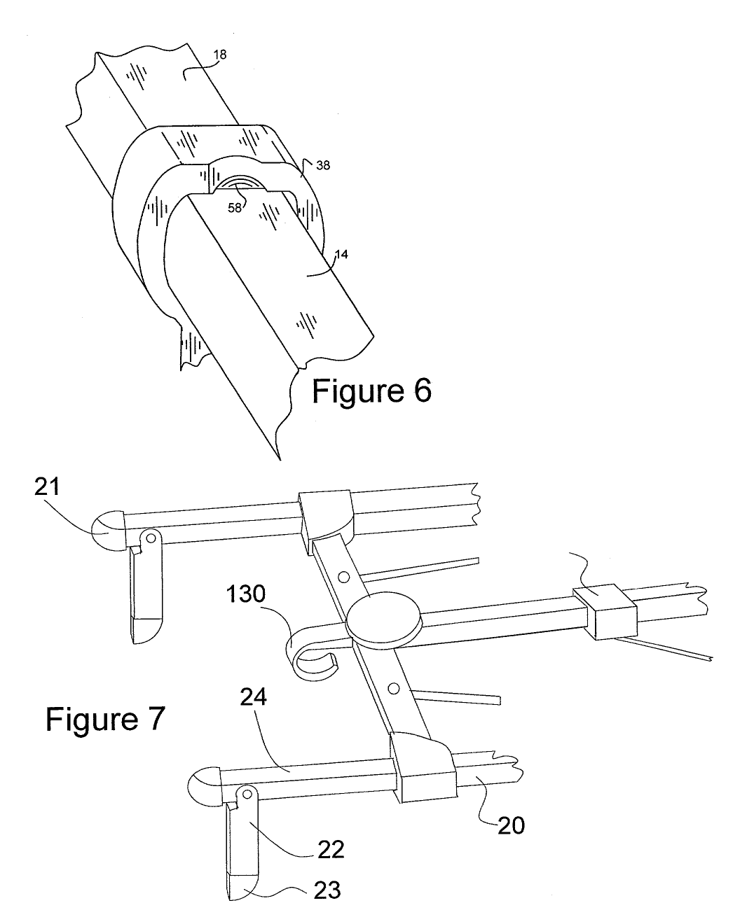

The opposing side of the upper hinge 38, shown in detail in FIG. 6, has a button-receiving alcove 58 that is dimensioned to interact with the upper brace button 50 in a manner to force the button 50 inward and enable the upper brace 12 to be slid into the mid-brace 14. Although the foregoing is the preferred embodiment, it should be noted that repositioning of the buttons for manual release would be evident to those skilled in the art. It should be noted that although the preferred embodiment provides ease of user use, other methods of maintaining and releasing the braces can be incorporated

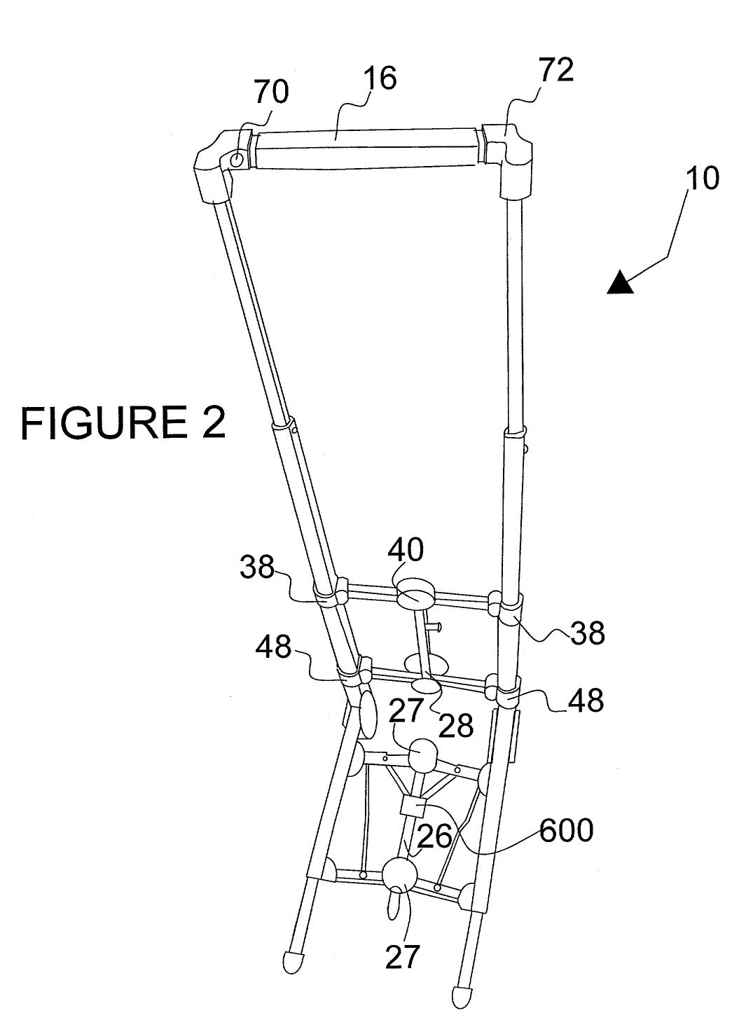

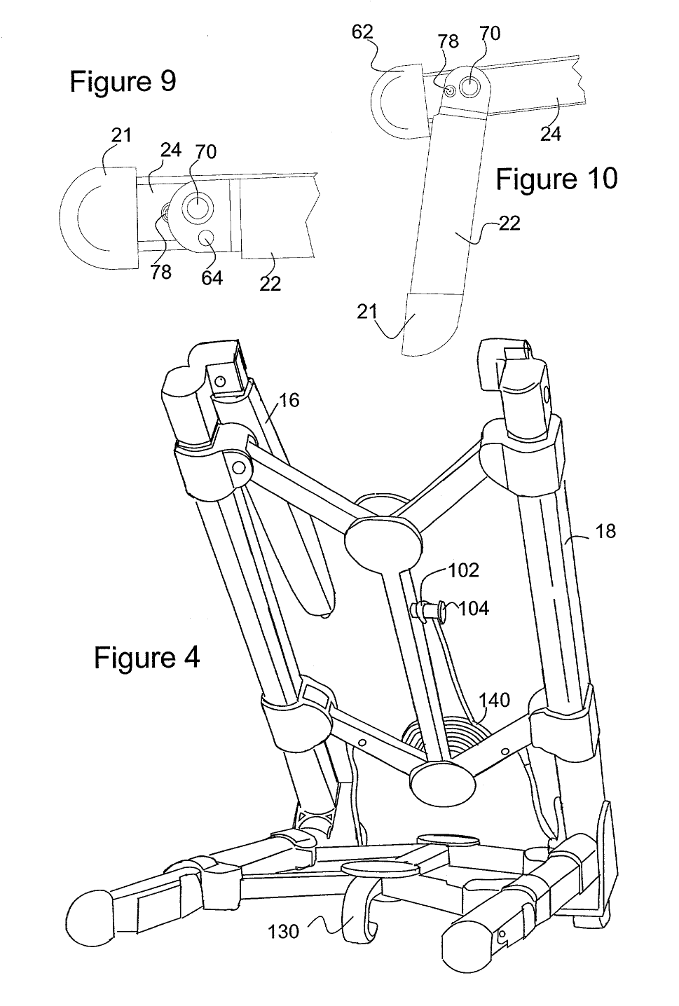

As can be seen clearly in FIGS. 1-4, the lower braces 18 serve to maintain the rigidity of the cart 10 and receive the upper handle brace 12 and mid-handle brace 14. The lower braces 18 are maintained distanced and “squared”, through the use of an upper cross support 30 and lower cross support 32. The upper cross support 30, as illustrated herein, is two-piece unit that is hingeably connected to the lower braces 18 at upper hinges 38, however the cross bars can divided in multiple sections and is a matter of manufacture preference. The two pieces forming the upper cross support 30 hingeably connect to one another on either side of the upper center hinge 40. The lower cross support 32 is a duplicate of the upper cross support 30; being hingeably connected to the lower hinges 48 as well as at the lower center hinge 28. It should be noted that any number of pieces can be hinged together to form the cross supports, depending upon size and weight of the unit and manufacture's preference, as long as they permit the cart to fold to the compact configuration illustrated hereinafter. To provide additional rigidity, the lower center hinge 28 and the upper center hinge 40 are connected by a brace 34.

To enable the cart 10 to fold into the compact configuration illustrated herein, the platform 20 must pivot around central platform hinges 27 which are connected by a bar 26. Placed along the bar 26 is the central lock 600 which serves as a central point for the braces 29 as well as, in some embodiments alternative method of preventing the platform 20 from folding. The central lock 600 is secured to the braces 29 to enable the bar 26 to move within the central lock 600 while the lock 600 moves independently along the bar 26 is accordance with the positioning of the braces 29.

The platform extensions 24, illustrated in this embodiment, provide additional receiving area on the platform 20 and although they are permanently extended in this embodiment, they can be dimensioned to side into the platform. The extension of the platform, along with the addition of a built-in bungie cord holder, overcomes one of the problems with prior art carts; the inability to carry larger pieces of luggage and to easily secure stacked pieces. To maintain the platform 20 in the horizontal position, and to prevent tipping, legs 22 are pivotly connected to the extensions 24. The platform legs 22, extended in this figure, are shown in more detail in FIGS. 7 and 8.

In the preferred embodiment a bungie storage knob is incorporated on the cart. In the embodiment illustrated, the bungie storage knob 140 is located on the lower center hinge 28, although any of the embodiments disclosed herein for bungie storage can also be located on the upper hinge, the front of the cart or other applicable location convenient for manufacture. The bungie storage knob 140 must be dimensioned to prevent contact with stairs, curbs, etc., and therefore must not be on the same plane as the lower braces 18 or wheel support 46. Preferably the wheel supports 46 are reinforced with metal in order to prevent cracking or breakage.

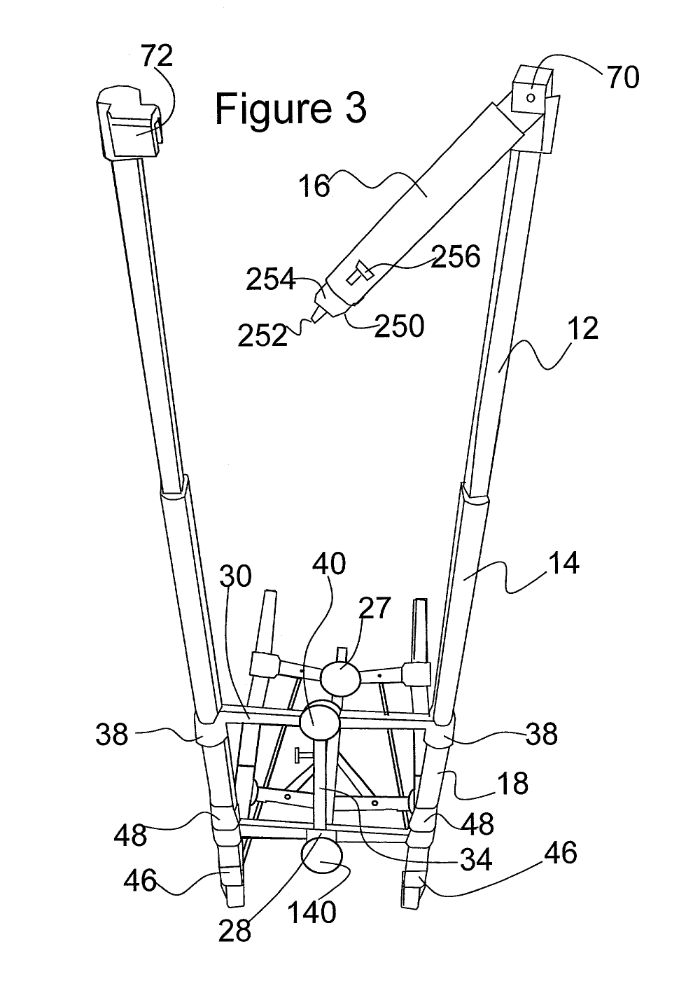

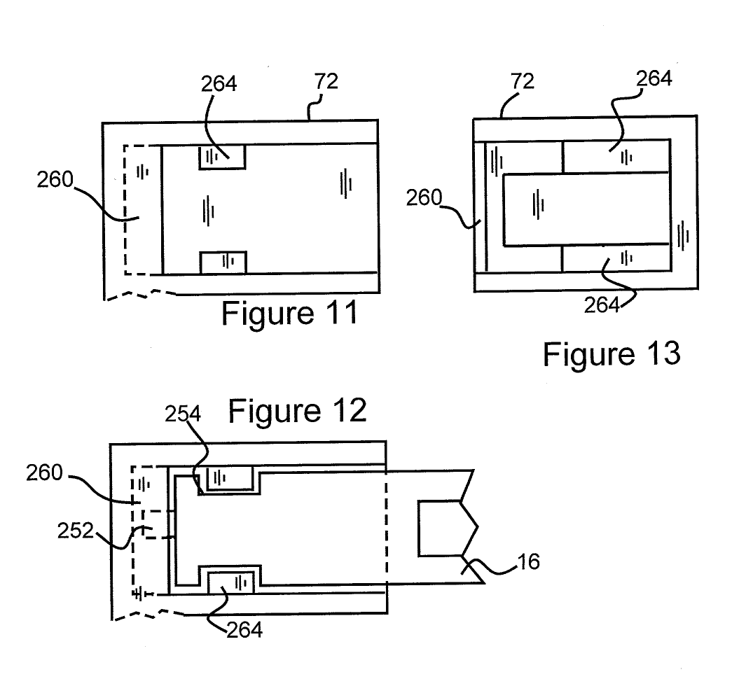

In FIG. 3 the handle 16 has been released and is part way to the vertical handle position that is required in order to collapse the cart 10. The handle 16 is hinged to the handle hinge 70 and is designed to lock into the handle-receiving end 72. The length of the handle 16 is equal to, or less than the length of the lower braces 18 to prevent the handle 16 from extending beyond the lower braces 18 when the cart 10 is in the folded position, as illustrated in FIG. 10. In order to maintain this ratio, the width of the cart 10, length of the handle 16 and length of the lower braces 18 must be about equal. The unique two-way locking mechanism 250 illustrated in this embodiment combines a button release 252 with a slide channel 254 that interacts with the interior of the handle-receiving end 72. The two-way locking mechanism 250 prevents the handle 16 not only from being inadvertently released in the downward direction, but from becoming horizontally dislodged. The preferred embodiment for the two-way locking mechanism 250 and interior of the handle-receiving end 72 are described in more detail hereinafter in conjunction with FIGS. 11-13. The button 252 is released in this embodiment through use of a spring loaded release lever 256 that pulls the button into the body of the handle 16, enabling downward movement of the handle 16. Although this is the preferred method of securing the handle 16 into the horizontal position required for use, other releasable methods that prevent both the release of the handle as well as the separation of the braces will be evident to those skilled in the art.

FIGS. 7 and 8 illustrate in more detail the platform 20, extensions 24 and legs 22 which rotate around a pivot 70. In the preferred embodiment, the legs 22 have a button lock 78 to keep them from inadvertently closing. The button lock 78, illustrated in detail in FIGS. 9 and 10, is located on the extension 24 and positioned to align with a receiving hole 74 on the rotatable leg 22. The locks illustrated herein are one example and other types of locks will be evident to those skilled in the art. The leg caps 23 keep the metal legs from scratching the support surfaces, catching on material, etc. The extension 24 are also provided with caps 21 to protect the user from the metal edges. In FIG. 8 a bumper 93 has been added to the back of the brace 18 to provide additional protection while going up stairs, curbs, etc. The bumper 93 can be any material that will serve to protect the brace 18 from damage and can be added to any of the embodiments disclosed herein.

In the embodiment illustrated herein a hook 130, shown in FIG. 7, is placed adjacent the platform front hinge 120. The hook 130 enables the bungie cord 100 of FIG. 9, to either be hooked onto the cord or wrapped around the hook 130 and secured on another location on the cart 10. Although smaller loops or hooks can also be used, the hook 130 illustrated in this Figure provides the benefit of enabling the folded cart 10 to be hung on a rod, hook, railing, etc. Alternatively, other hanging methods can be used to hang the folded cart such as a separate hanging hook that is either placed directly onto the cart or onto the illustrated hook 130.

Another problem associated with prior art carts is maintaining numerous items on the cart. With prior art devices, the user had to use separate bungie cords or rope to maintain multiple items in place. In FIG. 9 the incorporated cord, or bungie 100, can be seen on wrapped around the bunge cord holder 140. The bungie cord holder 140 is spaced from the lower center hinge 28, or other area of the cart 10, and connected through a bar (not shown). For storage purposes the bungie, or other type cord 100 is wrapped around the bar 142 and the bungie end hook 102 placed on the retaining pin 104. When used, the appropriate length of cord 100 is unwrapped from the holder 140 and the cord 100 stretched over the articles to be held. The bungie hook, or looped end, 102 is then hooked onto the hook 130, or other platform 20 location, securing the articles onto the cart 10. The use of the bar enables excess cord 100 to remain on the holder 140, thereby enabling the cord 100 to always be stretched tight. The retaining pin 104 can be any type of pin or hook that will serve to maintain the bungie hook 102 in position. The bungie hook 102 can also be secured during non-use directly to the platform 20 or other convenient location on the cart 10. Since the hook 102 is under tension, the retaining pin 104 will be as efficient as a loop or hook. Further, a hole in the center support bar 26 can also be used to retain the hook 102.

In FIGS. 11-13 the two way lock mechanism is illustrated in more detail. The U-shaped handle receiving end 72 is provided with a shelf 260 to support the handle button 252, preventing downward movement. The horizontal movement is prevent by the runners 264 that interact with the channels 254. Therefore, to lock the handle 16 in place, the release lever 256 is slid to withdraw the button 252 within the handle 16. The handle 16 is then slid into place with the runners 264 positioned within the channels 254 and the release lever 256 released to place the spring loaded button 252 in the extended position, between the shelf 260 and the top of the U-shaped handle receiving end 72. When the handle 16 is to be removed to enable the cart to be collapsed, the button 252 is again withdrawn into the handle 16, permitting the downward movement.

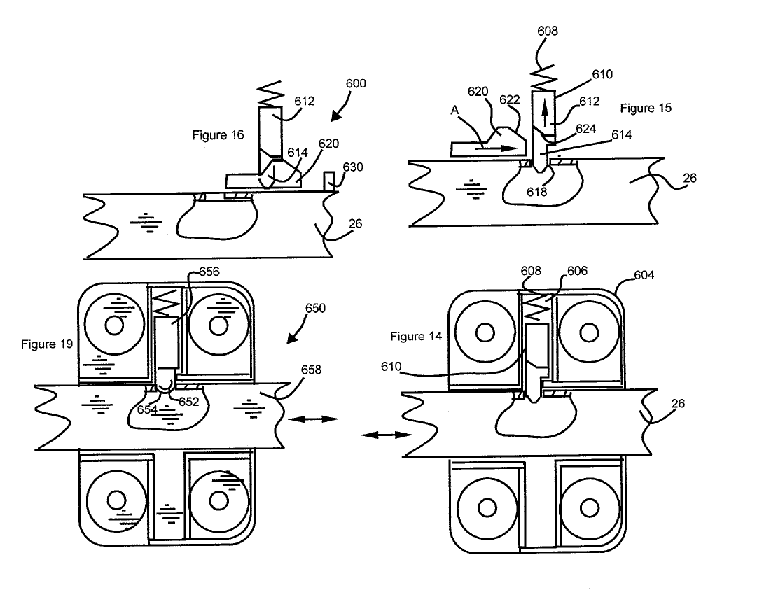

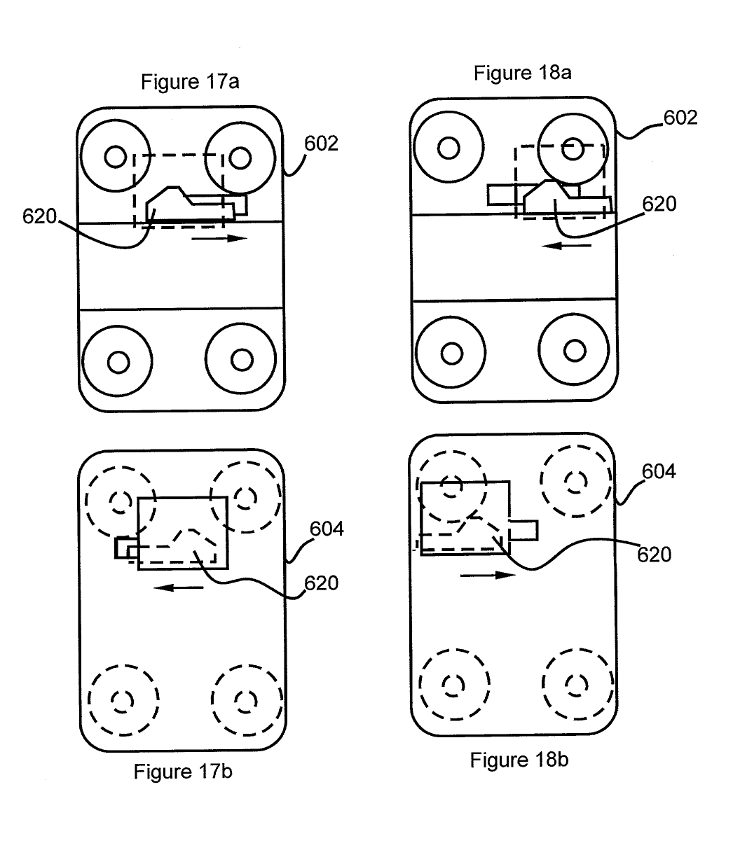

The interior of central lock 600 is illustrated in FIGS. 14-16 containing the parts that would enable to lock to prevent the platform from closing. The center lock 600 which serves as an alternate method of preventing the platform from closing and would be optional, except as a location for securing the braces 29, in embodiments using the handle locking system disclosed heretofore. In some instances, however, both locking devices can be advantageous. FIGS. 14-17 illustrate the interior and the method of operation of the center lock 600. The lock case is horizontally divided into a lower case 604 and an upper case 602. Within the lower case 604, at right angles to the bar 26, is a lock receiving area 606 that contains a spring 608 and locking member 610. The locking member 610 comprises a locking finger 614 and a raised side contact 612. In FIGS. 14, 15, 17a and 17b the central lock 600 is in the locked position. The locking finger 614 is, through pressure applied by the spring 608, extending into the receiving hole 618 within the bar 26, thereby preventing the bar 26 from sliding within the central lock 600. While the locking finger 614 is in the forward position, the slide 620 is in the position illustrated in FIGS. 15, 17a and 17b. To release the locking finger 614, the slide is moved in the direction of arrow A with the leading angle face 622 of the finger 614 interacting with the trailing edge 624 of the locking member 610. As the leading edge 622 moves in the direction of arrow A, the locking member 610 is forced against the spring 608 and the locking finger 614 removed from the receiving hole 618. Since the slide 620 is manually moved, without any spring return, the slide 620 remains in the position illustrated in FIGS. 16, 18a and 18b until it is reset. The reset is accomplished through the use of reset tab 630 that extends at right angles from the bar 26. As the platform is being closed, the bar 26 slides within the central lock 600 from the first extreme of being open to the second extreme of being tightly closed. The reset tab 630 is positioned to encounter the slide 620 just prior to the closed position so that, once moved to the start position illustrated in FIG. 15, the platform is closed. During the time that the platform is closed and until it is fully opened, the locking finger 614 runs along the exterior of the rod 26. As the central lock 600 is slid to the open position, the pressure applied to the locking finger 614 by the spring 608 forces the locking finger 614 into the receiving hole 18 once in position. Once this position has been reached, further movement is prevented until the slide 620, reset by the tab 630, is again manually moved as described heretofore.

In FIG. 19, an alternate central lock 650 is illustrated wherein the locking member 610 has been replaced with a locking member 656 containing a nipple 652. In this embodiment, the nipple 652 is maintaining within the receiving area 654 until the central lock 650 is manually moved out of position. The nipple 652, having rounded edges and being spring loaded, moves out of the receiving area 654 and runs along the exterior of the rod 658 until the unit is again reopened.

In FIG. 19 a removable bungie cord holder 200 is disclosed that can be clipped onto the any convenient location on the cart. The holder 200 has a front plate 202 that is connected to the back support 206 through the use of a connector 204. A pair of clips 208 (only one shown) can be slipped over the hinges or other portion of the cart. Dimensioning of the clips 208, however, is important as the depth of the clips 208 must be sufficient to prevent overdue strain while providing a tight, friction fit. The bungie holder can also be of any other design known for use with bungies, cords or other cord type devices. This includes retractable seatbelt type devices as well as mechanical mechanisms such as a crank or wind around bar that is, for example, pulled out to wind and pushed in to lock. The various method of storing the securing cords will be evident to those skilled in the art.

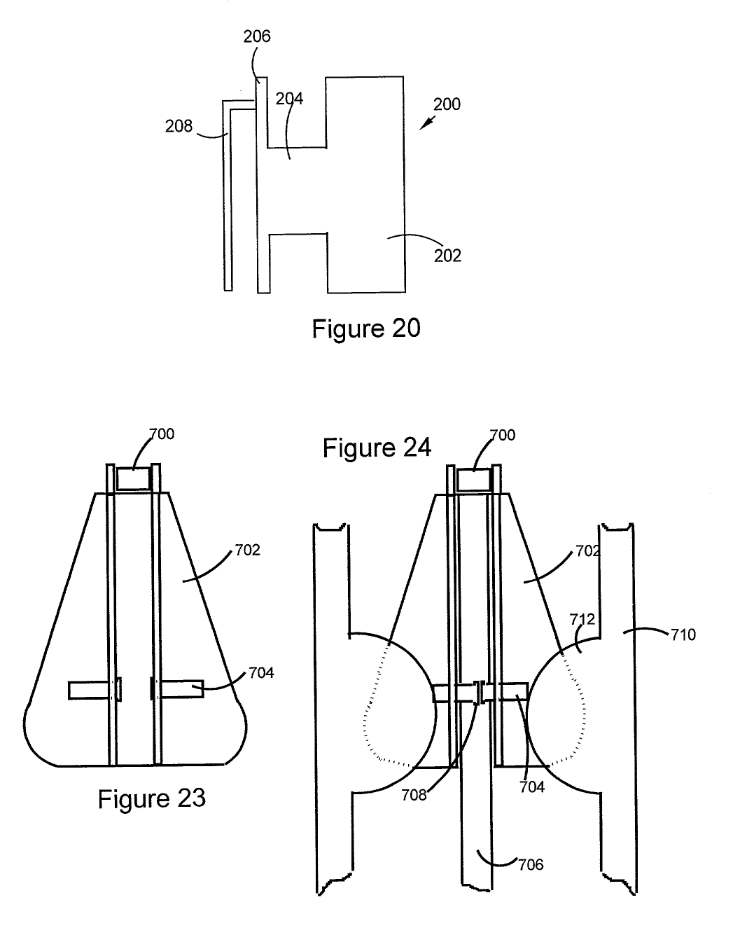

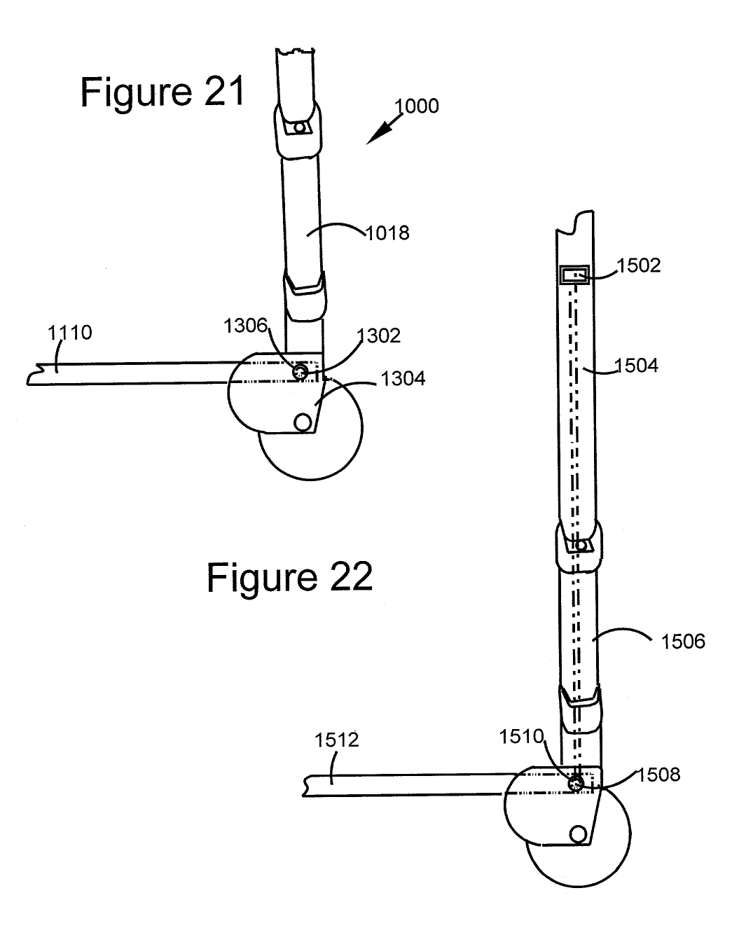

In order to prevent the cart 1000 from inadvertently folding, each of the wheel support plates 1304 shown in FIG. 20, contains a lock receiving area 1306 that interacts with the button lock 1302 affixed to the platform legs 1110. When in the open position, the button lock 1302 interacts with the receiving area 1306, preventing the platform legs 1110 from folding toward the braces 1018. To fold the cart 1000, the button locks 1302 are depressed and the platform legs 1110 folded upward. As an alternative, illustrated in FIG. 21, the button or other locking device 1506 can be connected to a release button 1502 that is attached to a cable 1504 that runs down the brace 1506. When the button 1502 is pushed in the lock 1508 is removed from the receiving hole 1510 and the legs 1512 are able to fold.

As an alternate to the legs 22 disclosed heretofore, a single, centered platform leg, attached to center brace 55, can be used. The platform leg can, as with any of the disclosed embodiments, be either spring loaded to automatically open or manually opened. FIGS. 22 and 23 illustrate one example of a method to maintain the platform leg 702 in the closed position. In FIG. 22, the underside of the platform leg 702 is illustrated showing the locking pins 704. Preferably the pins 704 are spring loaded to maintain them in the open position illustrated in FIG. 22. To close the folding cart, the platform leg 702 is pressed down and the cart folded. As the cart is folded, the half rounds 712 that house the pivot point for the cross brace (not shown) come in contact with the locking pins 704, forcing the locking pins 704 in toward the center brace 706. Receiving holes 708 within the center brace 706 are positioned and dimensioned to receive the locking pins 704 and maintain the platform leg 702 in the closed position. To release the platform leg 702, the locking pins 704 are removed from contact with the half rounds 712, thereby removing themselves from the receiving holes 708 and enabling the platform leg 702 to rotate to the open position

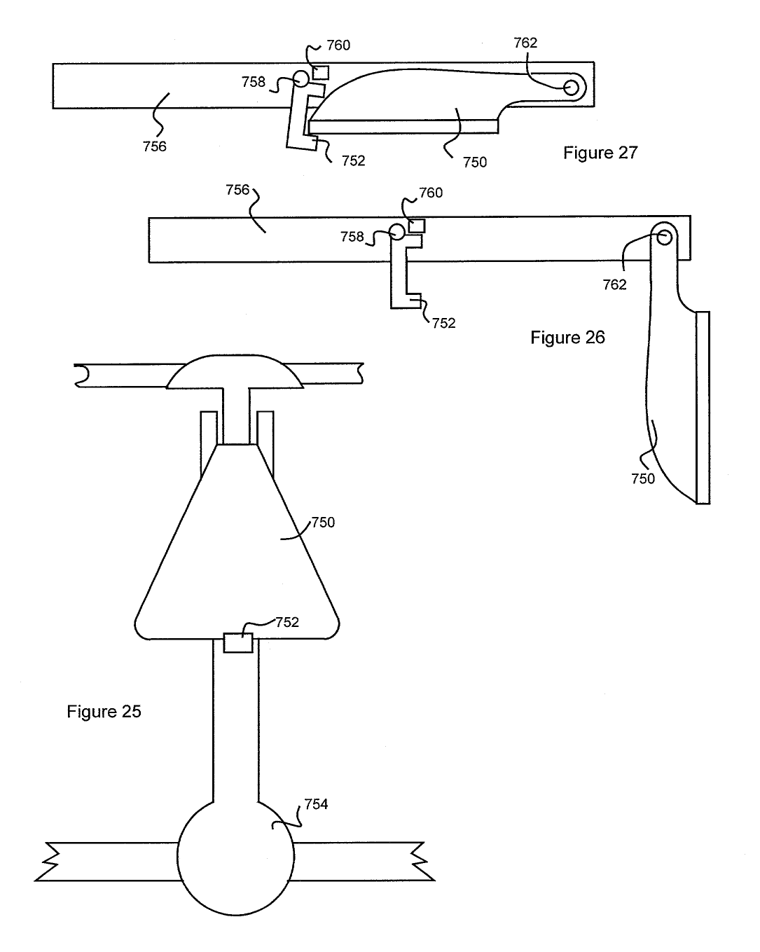

In FIGS. 24-26 the platform leg 750 is maintained in the closed position, as seen in FIGS. 18 and 20, by a spring lock 752. The spring lock 752 uses a spring 758, designed to maintain the spring lock 752 in the “closed” position as illustrated in FIG. 26. A stop 760 is used to prevent the spring 758 from rotating within the center bar 756. To release the platform leg 750, the spring lock 752 is moved toward the back hinge 754, releasing the platform leg 750. Preferably the spring lock 752 is designed to enable the platform leg 750 slide into place without having to manually release the lock 752, although it can be designed to require manually moving the lock 752 to accept the leg 750. This design is known in the art and any changes required will be evident to those skilled in the art. The platform let 750 can be attached to the center bar 756 through a spring-loaded hinge 762 that automatically opens the platform leg 750 upon release of the spring lock 752.

As seen in FIG. 26 the platform legs 810 are hollow and provided with telescoping extension legs 816 to extend the receiving length of the platform 820. In order to prevent the extension legs 816 from recessing totally within the platform legs 110, stop ends 818, of any convenience configuration, are placed on the ends of the extension legs 816. The stop ends 818 also provide convenient means for gripping the extension legs 816 and can be manufactured from any appropriate material. The outer diameter of the stop ends 818 must be greater than that of inner diameter of the platform legs 810 to prevent the extension legs 816 from recessing into the platform legs 810. The stop ends 818 must be manufactured from a shatter resistant material and be securely affixed to, or integral with, the extension legs 816. During the process of going up stairs or hills, all of the weight of the luggage is applied to these stop ends 818 and lightweight material will tend to break.

Although the preferred material of manufacture is a plastic, lightweight metal, such as aluminum, can also be used. Additionally, the materials can be mixed. Any of the features disclosed herein that are specific to a particular Figure can also be used with other embodiments disclosed herein.

1. A folding cart for the transportation of articles having a foldable platform, wheels, a handle and a pair of telescoping braces each of said telescoping braces having a lower brace, a middle brace and an upper brace and rotatable support bars there between, said telescoping braces connecting said platform and said handle, the improvements comprising: an offset handle hinge on a first of said pair of telescoping braces, said offset handle hinge rotatably connecting said handle to said first of said pair of telescoping braces;
an offset handle receiving area on a second of said pair of telescoping braces, said handle receiving area having a two way lock receiving area;
a handle, said handle having a two way locking member and a release, said two way locking member in locking engagement with said two way lock receiving area,
wherein placing said handle in a horizontal position within said two way locking member prevents said folding cart from being folded.

2. The folding cart of claim 1 wherein
said two way locking member comprises a slidable button at said handle distal end, said slidable button sliding in correlation to said release, and a pair of channels on opposing sides of said handle, said channels being spaced from said distal end; and said two way lock receiving area is an inverted U-shaped member having a open length, an open proximal end and a closed distal end, a shelf spanning said open length adjacent to said distal end and a pair of opposing runners, said opposing runners being dimensioned to be receiving within said channels,
wherein when said button is recessed within said distal end, said handle slides within said U-shaped receiving area and when said button is extended said button rests on said shelf

3. The folding cart of claim 2 further comprising a bungie cord holder, said bungie cord holder being affixed to one of said support bars.

4. The folding cart of claim 3 wherein said bungie cord holder is removable from said support bar.

5. The folding cart of claim 3 further comprising a bungie retaining hook, said bungie retaining hook being on an opposing side of said platform from said bungie cord holder.

6. The folding cart of claim 3 further comprising a bungie hook bar, said bungie hook bar extending from one of said support bars.

7. The folding cart of claim 2 further comprising bumpers, said bumpers being positioned along said lower brace to protect said lower brace during use with uneven surfaces.

8. The folding cart of claim 2 further comprising platform extensions, said platform extensions lengthening the article receiving area of said platform.

9. The folding cart of claim 8 wherein said platform extension are retractable within said platform.

10. The folding cart of claim 2 further comprising at least one rotatable support leg, said at least one support leg maintaining said platform horizontal when said platform is open and rotates adjacent to said platform when said platform is closed..

11. The folding cart of claim 10 wherein said at least one support leg is center on said platform.

12. The folding cart of claim 10 wherein said at least one support leg is a pair of rotatable support legs.

13. The folding cart of claim 12 wherein each of said support legs have locks.

14. A folding cart for the transportation of articles having a foldable platform, a handle and a pair of parallel telescoping braces, each of said telescoping braces having a lower brace, a middle brace and an upper brace, said telescoping braces connecting said platform and said handle, the improvements comprising:
a pair of upper hinges, each of said upper hinges being secured to a lower brace at a first telescoping point;
a horizontal bar, said horizontal bar extending between, and hinged to, each of said upper hinges,
a first telescoping lock, said first telescoping lock in a disengaged position enables said middle brace to descend into said lower brace and said first telescoping lock in an engaged position prevents said middle brace from descending into said lower brace;
a first lock release, said first lock release being positioned on said horizontal bar to release said first telescoping lock upon contact;
wherein folding said platform places said first lock release in contact with said first telescoping lock to disengage said first telescoping lock and opening said platform removes said first lock release to enable said first telescoping lock to engage.

15. The folding cart to claim 14 wherein said first telescoping lock is a compressible button on said middle brace and a receiving hole on said lower brace and said first lock release is a nipple on said bar to recess said compressible button.

16. The folding cart of claim 14 wherein each of said pair of upper hinges further comprises a second lock release, said second lock release being positioned to release a second telescoping lock between said middle brace and said upper brace as said middle brace is slide within said lower brace.

17. The folding cart of claim 16 further comprising a bungie cord holder, said bungie cord holder being affixed to one of said support bars.

18. The folding cart of claim 17 wherein said bungie cord holder is removable from said support bar.

19. The folding cart of claim 18 further comprising a bungie retaining hook, said bungie retaining hook being on an opposing side of said platform from said bungie cord holder.

20. The folding cart of claim 17 further comprising a bungie hook bar, said bungie hook bar extending from one of said support bars.

21. The folding cart of claim 14 further comprising bumpers, said bumpers being positioned along said lower brace to protect said lower brace during use with uneven surfaces.

22. The folding cart of claim 14 further comprising platform extensions, said platform extensions lengthening the article receiving area of said platform.

23. The folding cart of claim 22 wherein said platform extension are retractable within said platform.

24. The folding cart of claim 14 further comprising at least one rotatable support leg, said at least one support leg maintaining said platform horizontal when said platform is open and rotates adjacent to said platform when said platform is closed..

25. The folding cart of claim 24 wherein said at least one support leg is center on said platform.

26. The folding cart of claim 24 wherein said at least one support leg is a pair of rotatable support legs.

27. The folding cart of claim 26 wherein each of said support legs have locks.

28. A folding cart for the transportation of articles having a foldable platform, a handle and a pair of parallel telescoping braces, each of said telescoping braces having a lower brace, a middle brace and an upper brace, said telescoping braces connecting said platform and said handle, the improvements comprising:
a handle locking system, said handle locking system having:
an offset handle hinge on a first of said pair of telescoping braces, said offset handle hinge rotatably connecting said handle to said first of said pair of telescoping braces;
an offset handle receiving area on a second of said pair of telescoping braces, said handle receiving area having a two way lock receiving area being an inverted U-shaped member having a open length, an open proximal end and a closed distal end, a shelf spanning said open length adjacent to said distal end and a pair of opposing runners, said opposing runners being dimensioned to be receiving within said channels,
a handle, said handle having a two way locking member and a release, said two way locking member said two way locking member comprises a slidable button at said handle distal end, said slidable button sliding in correlation to said release, and a pair of channels on opposing sides of said handle, said channels being spaced from said distal end and interacting with said two way lock receiving area to lock said handle in a horizontal position and prevent separation of said pair of telescoping braces and said release enabling said handle to be removed from said two way lock receiving area,
wherein placing said handle within said two way locking member prevents said folding cart from being folded
wherein when said button is recessed within said distal end, said handle slides within said U shaped receiving area and when said button is extended said button rests on said shelf.
A telescoping lock release system, said release system having:
a pair of upper hinges, each of said upper hinges being secured to a lower brace at a first telescoping point;
a horizontal bar, said horizontal bar extending between, and hinged to, each of said upper hinges,
a first telescoping lock, said first telescoping lock being a compressible button on said middle brace and a receiving hole on said lower brace, said first telescoping lock being in a disengaged position enables said middle brace to descend into said lower brace and said first telescoping lock in an engaged position prevents said middle brace from descending into said lower brace;
a first lock release, said first lock release being a nipple on said bar positioned to recess said compressible button release upon contact;
a second lock release, said second lock release being positioned to release a second telescoping lock between said middle brace and said upper brace as said middle brace is slide within said lower brace.
wherein folding said platform places said first lock release in contact with said first telescoping lock to disengage said first telescoping lock and opening said platform removes said first lock release to enable said first telescoping lock to engage.

29 A folding cart for the transportation of articles having a foldable platform, wheels, a handle and a pair of telescoping braces each of said telescoping braces having a lower brace, a middle brace and an upper brace and rotatable support bars there between, said telescoping braces connecting said platform and said handle, the improvements comprising:
a center lock, said center lock maintaining said foldable platform in an open position, said center lock being placed on a center rod of said platform, said center rod having a receiving notch, said center lock having:
a lower lock case, said lower lock case having
a rod receiving channel;
a locking area containing a locking member and a spring, said spring applying pressure to said locking member to position said locking member within said receiving notch;
an upper lock case, said upper lock case having a slide, said slide interacting with said locking member to remove said locking member from said receiving notch.

30. The cart of claim 29 further comprising said center rod having a release tab, said release tab interacting with said upper lock case slide to remove said slide from interaction with said locking member.
